(19) United States
(12) Patent Application Publication
(10) Pub. No.: US 2025/0384220 A1
(43) Pub. Date: Dec. 18, 2025

(54) METHOD AND APPARATUS FOR GENERATING MESSAGE

(71) Applicant: KAKAO CORP., Jeju-si (KR)

(72) Inventor: Hui Su KIM, Seongnam-si (KR)

(73) Assignee: KAKAO CORP., Jeju-si (KR)

(21) Appl. No.: 19/234,125

(22) Filed: Jun. 10, 2025

(30) Foreign Application Priority Data
Jun. 14, 2024 (KR) 10-2024-0077703

(51) Int. Cl. G06F 40/40; G06F 40/166; H04L 51/06

(52) U.S. Cl. CPC G06F 40/40; G06F 40/166; H04L 51/06

(57) ABSTRACT

A server including a processor configured to receive a message generation request for a chatroom from a user terminal and to initiate generation of at least one candidate message by inputting a source message, transmitted and received through the chatroom, into a message generating model. When information indicating a text input in an input box of the chatroom is received from the user terminal before the generation of the at least one candidate message is completed, the processor stops the generation of the at least one candidate message. When information indicating the text input in the input box of the chatroom is not received from the user terminal until the generation of the at least one candidate message is completed, the processor transmits information on the generated at least one candidate message to the user terminal.

### CROSS-REFERENCE TO RELATED APPLICATION

This application claims the benefit of Korean Patent Application No. 10-2024-0077703 filed on Jun. 14, 2024, in the Korean Intellectual Property Office, the entire disclosure of which is incorporated herein by reference for all purposes.

### BACKGROUND

### Technical Field

One or more embodiments relate to a technology for generating a candidate message.

### Description of the Related Art

Recently, with the development of mobile smart devices, use of an online platform service to communicate with other users via a network has increased. The online platform services for communication with other users may include, as representative examples, a social networking service (SNS) which is an online platform for generating and consolidating social relationships through communication among users, information sharing, and expansion of personal connections, and an instant messaging service (IMS) which is an online platform for real-time content communication between two or more users. An increase in communication between users via mobile devices has allowed the online platform services to support a function for providing various services based on communication between a plurality of users in addition to a chat service for daily conversations with other users.

### BRIEF SUMMARY

Traditional messaging systems that generate automated responses often lack responsiveness to user behavior, resulting in wasted computational resources and poor user experience. These systems also fail to integrate message drafting and style conversion fluidly within a unified interface. The disclosed technology addresses these limitations by introducing a responsive system that adapts its operations in real time based on user input activity and context.

The disclosed method and system provide context-aware candidate message generation in chat applications with dynamic responsiveness to user behavior. Message generation is automatically stopped if the user begins typing or closes the keyboard, which improves system efficiency and aligns with user intent. The system supports various options such as positive or neutral tones and allows the user to request new candidate messages by modifying parameters of the language model, such as temperature. It also transitions between message generation and text conversion functions depending on whether the input field is empty or contains text, supporting both message drafting and refinement.

Additional features include generating responses based on selected messages within a conversation or based on emotion expression elements such as emojis. The system can also recommend appropriate emotion expressions based on the content of selected candidate messages. It supports both cloud-based and device-based execution and adapts its interface depending on platform type and user interaction. The system includes mechanisms to notify the user when message generation is unavailable due to limitations such as lack of text input or network issues.

For example, according to an aspect, there is provided a method performed by a server, the method including receiving a message generation request for a chatroom from a user terminal, starting generation of at least one candidate message by inputting a source message transmitted and received through the chatroom to a message generating model, when information on a text input of an input box of the chatroom is received from the user terminal before the generation of the at least one candidate message is completed, stopping the generation of the at least one candidate message, and when the information on the text input of the input box of the chatroom is not received from the user terminal until the generation of the at least one candidate message is completed, transmitting information on the generated at least one candidate message to the user terminal.

The text input may include a user input of adding a text to the input box in which a text is not input.

The method may further include, for each of a plurality of manners, obtaining input data including a prompt corresponding to a corresponding manner, and the source message, and generating a plurality of candidate messages corresponding to the plurality of manners by applying the message generating model to the obtained input data.

The method may further include, when a re-generation request for the at least one candidate message is received from the user terminal, adjusting a set value of the message generating model, and generating at least one additional candidate message from the source message using the message generating model having the adjusted set value.

The method may further include, when information on stopping displaying a keyboard object for adding a text to the input box of the chatroom is received from the user terminal before the generation of the at least one candidate message is completed, stopping the generation of the at least one candidate message.

The method may further include receiving, from the user terminal, a transmission request for a message obtained by modifying at least a portion of a text of a candidate message selected from among the at least one candidate message or adding an emotion expression object to the selected candidate message, and transmitting the message based on the selected candidate message to another user terminal of another user account that has participated in the chatroom.

The receiving of the message generation request may include receiving the message generation request of requesting for a response to a target message specified among messages transmitted and received through the chatroom, and the starting of the generation of the at least one candidate message may include inputting the source message and the target message to the message generating model.

The receiving of the message generation request may include receiving, from the user terminal, the message generation request of requesting for generation of a text to be transmitted together with an emotion expression object selected from among candidate emotion expression objects.

The method may further include, when information on a user input of selecting a candidate message from among the at least one candidate message is received, selecting a recommended emotion expression object based on the selected candidate message, and transmitting information on the selected recommended emotion expression object to the user terminal.

The method may further include, while a text is not present in the input box of the chatroom, providing the user terminal with a message generation function of generating the at least one candidate message, and when a text is added to the input box of the chatroom, stopping providing the message generation function.

The method may further include, while a text is present in the input box of the chatroom, providing the user terminal with a text conversion function of converting a text input to the input box, and when the text is removed from the input box of the chatroom, stopping providing the text conversion function and resuming providing the message generation function.

According to an aspect, there is provided a server including a processor, and a memory configured to store instructions, wherein the instructions, when executed by the processor, cause the server to receive a message generation request for a chatroom from a user terminal, start generation of at least one candidate message by inputting a source message transmitted and received through the chatroom to a message generating model, when information on a text input of an input box of the chatroom is received from the user terminal before the generation of the at least one candidate message is completed, stop the generation of the at least one candidate message, and when the information on the text input of the input box of the chatroom is not received from the user terminal until the generation of the at least one candidate message is completed, transmit information on the generated at least one candidate message to the user terminal.

According to an aspect, there is provided a method performed by a user terminal, the method including obtaining a message generation request for a chatroom, starting generation of at least one candidate message by inputting a source message transmitted and received through a chatroom to a message generating model in response to the obtained message generation request, based on the generation of at least one candidate message being started, displaying a screen indicating that the generation of the at least one candidate message is started, when a text input of an input box of the chatroom is received before the generation of the at least one candidate message is completed, stopping the generation of the at least one candidate message and the displaying of the screen, and when the text input of the input box of the chatroom is not received until the generation of the at least one candidate message is completed, obtaining information on the generated at least one candidate message and displaying the at least one candidate message.

According to an aspect, there is provided a user terminal including a processor, and a memory configured to store instructions, wherein the instructions, when executed by the processor, cause the user terminal to obtain a message generation request for a chatroom, start generation of at least one candidate message by inputting a source message transmitted and received through the chatroom to a message generating model in response to the obtained message generation request, based on the generation of at least one candidate message being started, display a screen indicating that the generation of the at least one candidate message is started, when a text input of an input box of the chatroom is received before the generation of the at least one candidate message is completed, stop the generation of the at least one candidate message and the displaying of the screen, and when the text input of the input box of the chatroom is not received until the generation of the at least one candidate message is completed, obtain information on the generated at least one candidate message and display the at least one candidate message.

The disclosed method improves the operation of messaging platforms by reducing redundant computation through proactive cancellation of background tasks when user intent shifts to manual input. This reduces server load and improves response latency, which are technical benefits not tied solely to the message content.

In some embodiments, the disclosed system includes functional coordination between the user terminal and the server to manage computing resources based on user interaction states. Specifically, when the user terminal detects a text input in the input box of a chatroom or detects that the keyboard used to enter such input is dismissed, it transmits corresponding information to the server. The server, upon receiving this information and confirming that candidate message generation is still ongoing, halts the generation process before completion. This reduces unnecessary use of computational resources, minimizes network traffic, and improves responsiveness for the user. The ability to dynamically control the generation process based on real-time interaction information allows the system to operate efficiently within constrained computing environments such as mobile devices, and also enhances overall system performance compared to conventional messaging platforms that passively generate automated responses without regard for changing user behavior.

Additional aspects of example embodiments will be set forth in part in the description which follows and, in part, will be apparent from the description, or may be learned by practice of the disclosure.

### BRIEF DESCRIPTION OF THE SEVERAL VIEWS OF THE DRAWINGS

These and/or other aspects, features, and advantages of the disclosure will become apparent and more readily appreciated from the following description of example embodiments, taken in conjunction with the accompanying drawings of which:

FIG. 1 is a diagram illustrating an example of a message generation system according to various embodiments;

FIG. 2 is a diagram illustrating an example of a message generation method performed by a server according to various embodiments;

FIGS. 3 and 4 illustrate examples of interfaces of a user terminal that switches between a message generation function and a text conversion function according to various embodiments;

FIG. 5 is a diagram illustrating an example of an operation of generating a candidate message by a message generation system according to various embodiments;

FIG. 6 is a diagram illustrating an example of an operation of regenerating a candidate message by a message generation system according to various embodiments;

FIG. 7 is a diagram illustrating an example of an operation of transmitting a message based on a candidate message by a message generation system according to various embodiments;

FIG. 8 is a diagram illustrating an example of an operation of stopping generation of a candidate message according to a text input by a message generation system according to various embodiments;

FIG. 9 is a diagram illustrating an example of an operation of stopping generation of a candidate message according to stopping display of a keyboard object by a message generation system according to various embodiments;

FIG. 10 is a diagram illustrating an example of an operation of generating a candidate message for a response to a target message by a message generation system according to various embodiments;

FIG. 11 is a diagram illustrating an example of an operation of generating a candidate message subsequent to selection of an emotion expression object by a message generation system according to various embodiments;

FIG. 12 illustrates an example of an operation of providing a recommended emotion expression object according to selection of a candidate message by a message generation system according to various embodiments;

FIG. 13 is a diagram illustrating an example of a guidance message guiding that a candidate message may not be generated in response to a message generation request by a message generation system;

FIG. 14 is a diagram illustrating examples of a user interface provided on a user terminal of a message generation system according to various embodiments; and

FIG. 15 is a diagram illustrating an example of a hardware configuration of a system for a message generation service according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, the embodiments will be described in detail with reference to the accompanying drawings. When describing the embodiments with reference to the accompanying drawings, like reference numerals refer to like elements and a repeated description related thereto will be omitted.

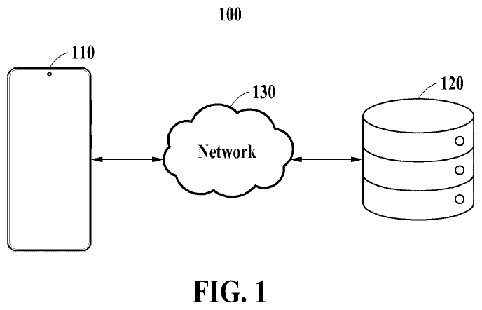

FIG. 1 is a diagram illustrating an example of a message generation system according to various embodiments.

A message generation system 100 according to an embodiment may include a user terminal 110, a server 120, and a network 130.

The user terminal 110 may be one of electronic devices including a computer, a portable computer, a wireless phone, a mobile phone, a smartphone, a personal digital assistant (PDA), a web tablet, a wearable device, and the like, and may refer to any device that may install or execute an application (hereinafter, also simply referred to as an “app”) related to the server 120 or execute a web. In this case, under the control of an app or a web, the user terminal 110 may perform overall service operations, such as service screen setting, data input, data transmission and reception, and data storage. The user terminal 110 may process a user interface (UI) or user interaction through a processor and output or transmit a processing result through an output device of the user terminal 110.

The user terminal 110 may execute an app or a web related to a service provided by the server 120. A user may use the service provided by the server 120 by executing an app or a web related to the service through the user terminal 110.

The server 120 according to an embodiment may include a server that provides an instant messaging service (IMS) a social networking service (SNS), and/or a message generation service via the network 130.

The server 120 may provide a service to the user terminal 110. According to an embodiment, the server 120 may include an instant messaging server (not shown) and a message generation server (not shown). The instant messaging server may provide an IMS to the user terminal 110. The message generation server may provide a message generation service to the user terminal 110. The message generation service may provide generation and/or regeneration of candidate messages to the user terminal 110. As will be described later, a candidate message may include a draft of a message.

The server 120 may be linked with a web for the service or an app for the service executed by the user terminal 110 to provide a UI, a function, an operation, or a service.

A user account is created when a user signs up for a service provided by the server 120, and the server 120 may serve as a service platform that provides a service to a user account registered for a service such as an SNS, an IMS, and the like. In various embodiments of the present disclosure, a user account will be mainly described as an account subscribing to an IMS. Since the user terminal 110 uses a service using the user account, the user account included in the following embodiments may be construed as corresponding to the user terminal 110.

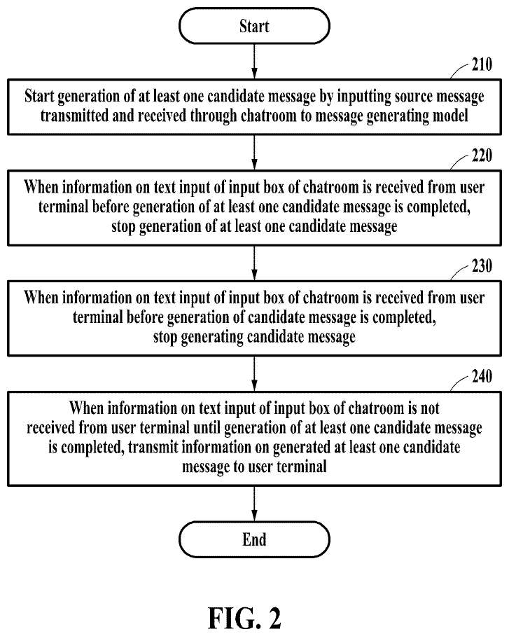

FIG. 2 is a diagram illustrating an example of a message generation method performed by a server according to various embodiments.

Hereinafter, in an embodiment, operations may be performed sequentially, however, in various embodiments, operations may not be limited to being performed sequentially. For example, the order of the operations may be changed and/or at least two of the operations may be performed in parallel.

A server (e.g., the server 120 of FIG. 1) according to an embodiment may provide a candidate message as a draft of a message to be transmitted in the IMS to a user terminal (e.g., the user terminal 110 of FIG. 1). During the generation of the candidate message, when the user terminal receives a user input corresponding to stopping the generation of the candidate message, the server may stop the generation of the candidate message.

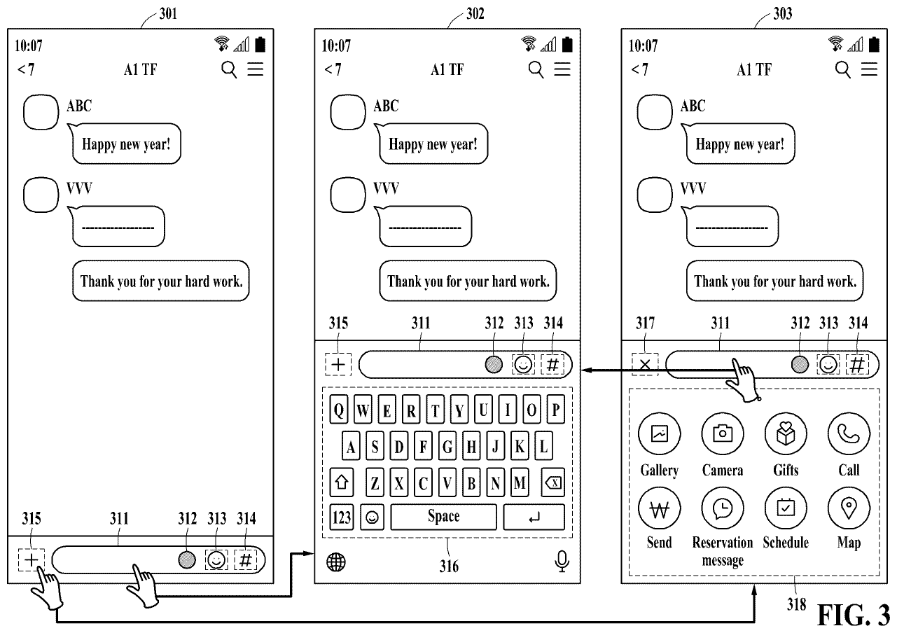

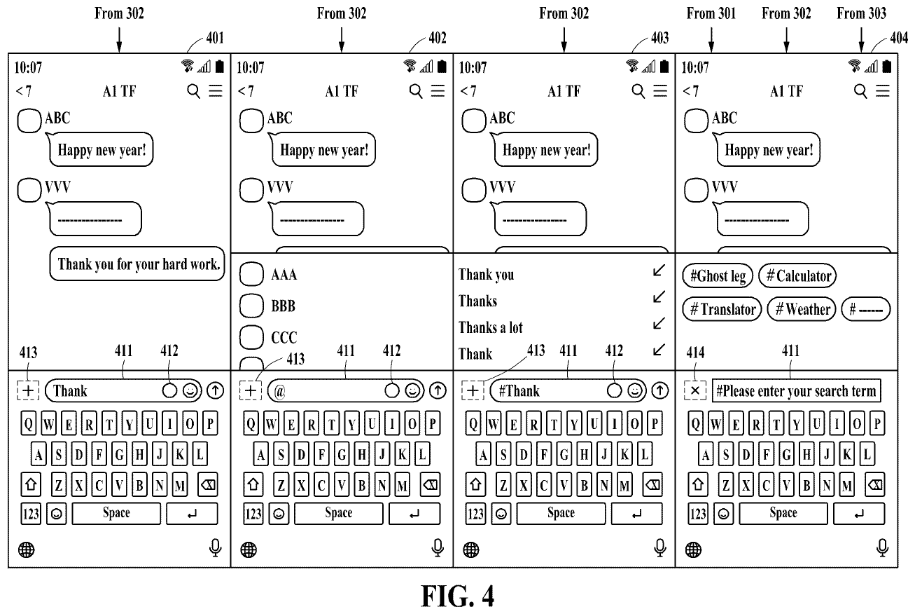

The server may receive a message generation request for a chatroom from the user terminal. A chatroom may include a chatroom in which a user account of a user terminal and at least another user account participate. The user terminal may display a button corresponding to a message generation function (hereinafter, also referred to as a “message generation button”) on a screen corresponding to a chatroom (hereinafter, also referred to as a “chatroom screen”). As will be described later with reference to FIGS. 3 and 4, the server may control the user terminal to display the message generation button when activation conditions of the message generation function are satisfied. The server may control the user terminal not to display the message generation button when the activation conditions of the message generation function are not satisfied.

The user terminal may transmit the message generation request to the server. For example, the user terminal may receive a user input of selecting the message generation button on the chatroom screen. The user terminal may transmit information on the user input for the message generation button to the server as the message generation request. The message generation request may include information indicating a chatroom associated with the message generation button. The server may receive the information on the user input for the message generation button from the user terminal as the message generation request.

In operation 210, the server may start generation of at least one candidate message (hereinafter, also simply referred to as a “candidate message” in this specification) by inputting a source message sent and received through a chatroom to a message generating model. The server may start the generation of the candidate message in response to the message generation request.

The source message may include at least one message sent or received through a chatroom. According to an embodiment, the source message may include a predetermined number of last messages among the at least one message sent and received through the chatroom. The source message, as an input of the message generating model, may be preprocessed to satisfy an input format of the message generating model.

The message generating model may include a model generated and/or trained to output output data including information on the candidate message by applying input data about one or more source messages. For example, the message generating model may be constructed based on a machine learning model (e.g., a neural network or large language model (LLM)).

The input data may include information on a chatroom (e.g., the number of participants), information on elements (e.g., a text, image, and emoticon expression object) included in each source message, the time each source message was written, and/or information on a sender of each source message. Each message may include at least one of a text, an image, or an emotion expression object. The text may include at least one of a character (e.g., “A” or “z”), a number (e.g., “0” or “5”), or a special character (e.g., “@,” “#,” or “$”). The image may include a photograph, a picture, or a video including a plurality of image frames. The emotion expression object may include at least one of an emoji, an emoticon, or a sticker expressing an emotion.

According to an embodiment, the input format of the message generating model may be a text format.

For example, the server may select a message including a text from among a plurality of messages sent and received through the chatroom as the source message. For example, when the message(s) sent and received through the chatroom include only emotion expression objects and/or images and do not include texts, the server or the user terminal may provide (e.g., transmit or display) a guidance message guiding that it is not possible to generate the candidate message.

For example, the server may replace an image or an emotion expression object included in the message with a text. The server may convert the input format of the message generating model to the text format by replacing the image or emotion expression object included in the message with a corresponding text. For example, a text corresponding to an image or an emotion expression object may include a text obtained by applying image captioning to the image or the emotion expression object. A text corresponding to an image or an emotion expression object may include, for example, a text mapped to the image or the emotion expression object. The text mapped to the image or the emotion expression object may be specified in advance by a service provider or may be input by a user as a description of the image or the emotion expression object.

However, the message generating model according to various embodiments of the present disclosure is not limited to having a text input format. For example, the message generating model may have an input format for the image and/or emotion expression object along with the text.

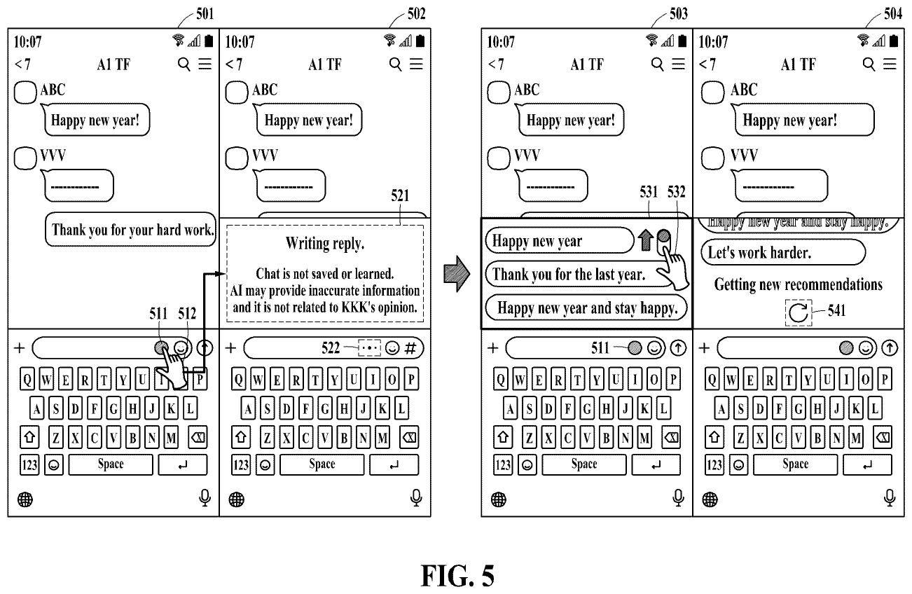

The generation of the candidate message using the message generating model will be described in more detail below with reference to FIG. 5.

The user terminal may display a screen indicating that the generation of the candidate message is started by the server. The display on the screen indicating that the generation of the candidate message is started will be described in more detail below with reference to FIG. 5.

In operation 220, when information on a text input of an input box of the chatroom is received from the user terminal before the generation of the at least one candidate message is completed, the server may stop the generation of the at least one candidate message. The text input of the input box may include a user input of adding a text to the input box (e.g., an input box to which a text is not input).

The input box of the chatroom may include a block and/or an area for inputting a text of a message. A user may input a text to the input box and transmit the text input to the input box as at least a portion of a message through a chatroom by selecting a transmission button. However, it is not limited to that only a text is able to be input to the input box. When there is a specific emotion expression object that is set to be input to the input box by the service provider, the specific emotion expression object may be input to the input box.

The user terminal may receive the text input of the input box before the generation of the candidate message is completed (e.g., at a time point after the generation of the candidate message starts and before the generation of the candidate message is completed) by the server. The user terminal may transmit the information on the text input to the server. In operation 230, when the information on the text input is received from the user terminal before the generation of the candidate message is completed, the server may stop the generation of the candidate message. The server may transmit information indicating to stop the generation of the candidate message to the user terminal. In response to the generation of the candidate message being stopped, the user terminal may stop displaying the screen indicating that the generation of the candidate message is started.

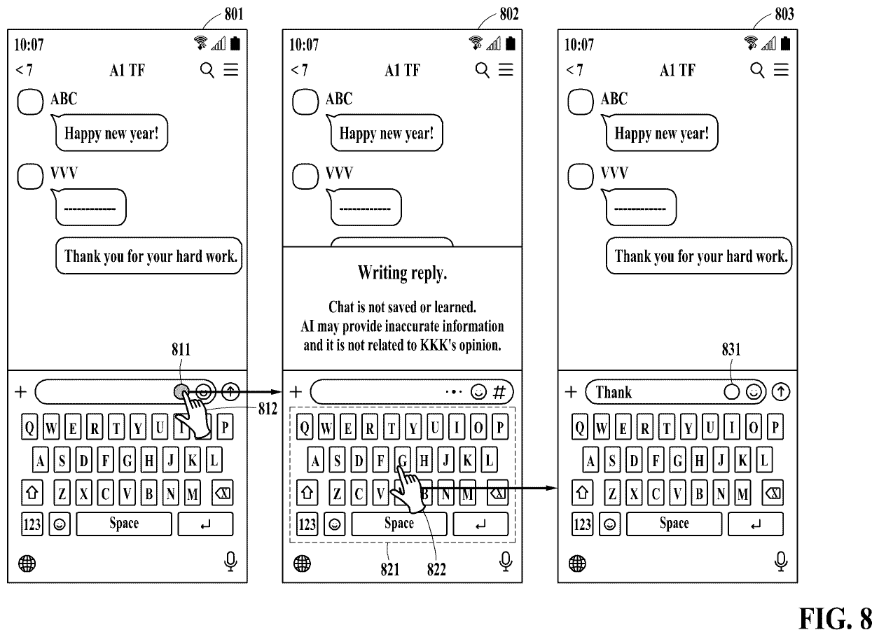

When an input (e.g., the text input) having an intent to directly write a message is received before receiving a draft (e.g., the candidate message) of the message after the user requests the generation of the draft, the message generation system according to an embodiment may determine that the request for the generation of the draft of the message is withdrawn. An interface related to the stopping of the message generation based on the text input will be described below with reference to FIG. 8.

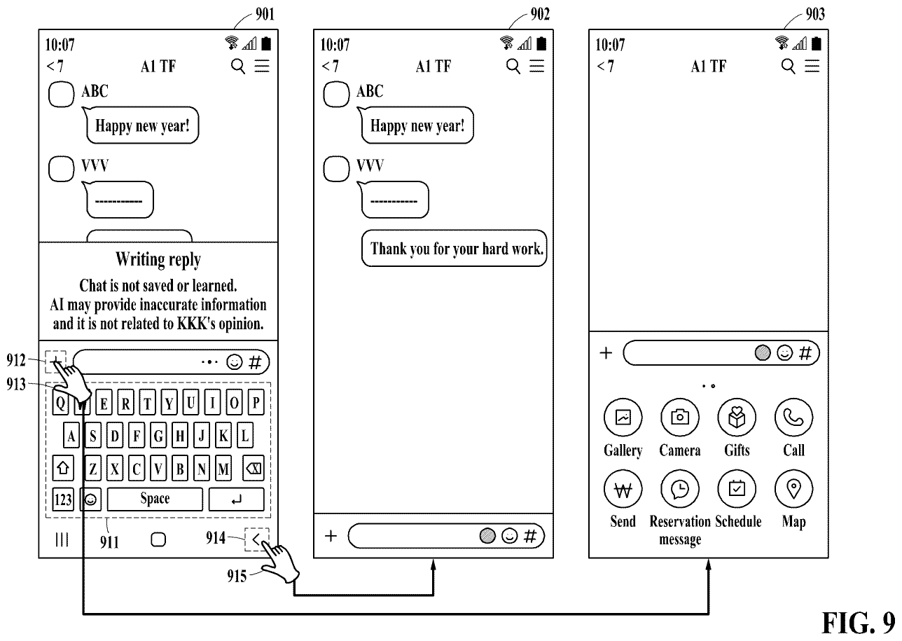

The server according to various embodiments of the present disclosure is not limited to stopping the message generation based on the text input. For example, the server may stop the message generation based on a user input of stopping display of a keyboard object. The stopping of the message generation due to the stopping of the display of the keyboard object will be described in more detail below with reference to FIG. 9.

In operation 240, when the information on the text input of the input box of the chatroom is not received from the user terminal until the generation of the at least one candidate message is completed, the server may transmit information on the generated at least one candidate message to the user terminal.

When the generation of the candidate message is completed, the server may transmit the information on the candidate message to the user terminal. When the text input of the input box of the chatroom is not received until the generation of the candidate message is completed, the user terminal may receive the information on the candidate message from the server. The user terminal may display the candidate message generated using the received information on the candidate message.

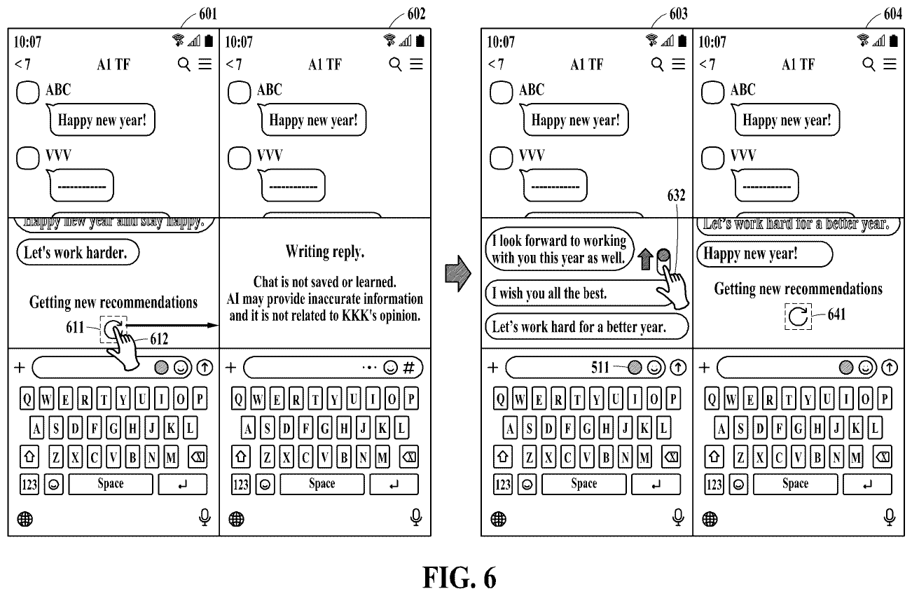

The user may request regeneration if the generated candidate message is not satisfied. For example, the user terminal may display a regeneration button together with the candidate message. The regeneration of the candidate messages will be described in more detail below with reference to FIG. 6.

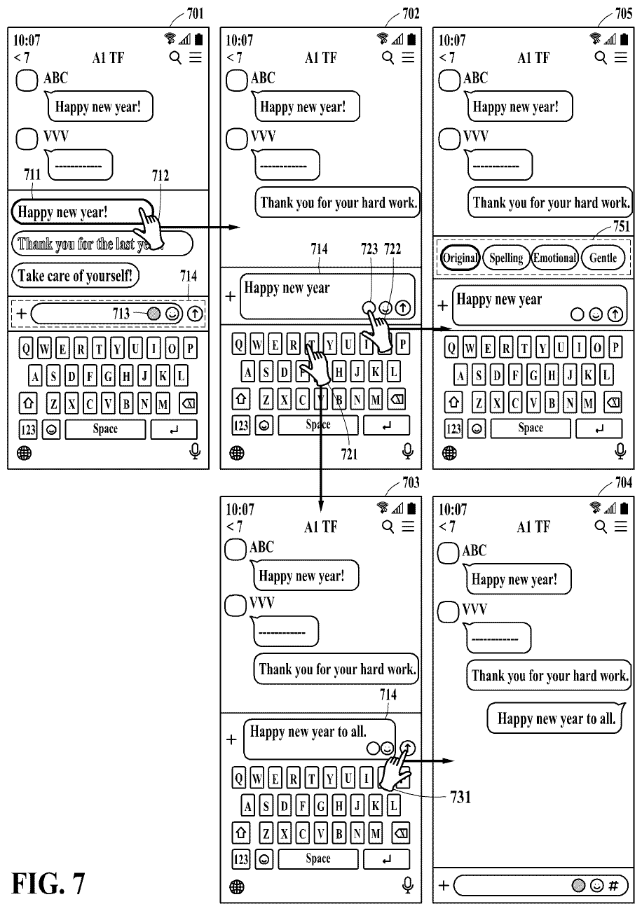

When the user selects the generated candidate message, the user may write a message using the candidate message as a draft of the message. For example, when the user input of selecting the candidate message is received, the user terminal may request the transmission of a message based on the candidate message. The writing of a message based on the candidate message will be described in more detail below with reference to FIG. 7.

Although FIG. 2 mainly describes that the server generates the candidate message, it is not limited to that the server of the message generation system according to various embodiments of the present disclosure generates the candidate message. According to an embodiment, the user terminal of the message generation system may generate a candidate message using a message generating model stored within the user terminal. For example, when a user input for the message generation button is received, the user terminal may obtain the user input as a message generation request. The user terminal may start the generation of the candidate message by inputting the source message to the message generating model in response to the message generation request. The user terminal may display a screen indicating that the generation of the candidate message is started, based on that the generation of the candidate message is started. When the text input is received before the generation of the candidate message is completed, the user terminal may stop the generation of the candidate message and the display of the screen. When the text input is not received until the generation of the candidate message is completed, the user terminal may obtain the information on the generated at least one candidate message, and display the at least one candidate message. The starting of the generation of the candidate message, the generation of the candidate message, and/or the stopping of the generation of the candidate message by the user terminal may be performed in the same or similar manner as the starting of the generation of the candidate message, the generation of the candidate message, and/or the stopping of the generation of the candidate message by the server described in various embodiments of the present disclosure. All or some of operations of the server described with reference to FIGS. 3 to 14 may be performed by the user terminal.

In various embodiments of the present disclosure, an embodiment in which the server of the message generation system generates a candidate message may be expressed as “on-cloud,” and an embodiment in which the user terminal of the message generation system generates a candidate message may be expressed as “on-device.”

FIGS. 3 and 4 illustrate examples of interfaces of a user terminal that switches between a message generation function and a text conversion function according to various embodiments.

A server according to an embodiment may determine whether to enable the message generation function based on whether a text is present in an input box of a chatroom.

The server may provide the message generation function of generating a candidate message to the user terminal while a text is not present in the input box of the chatroom. The server may stop providing the message generation function when a text is added to the input box of the chatroom.

In various embodiments of the present disclosure, the server providing a specific function to the user terminal may include causing the user terminal to display a button corresponding to the specific function. The button corresponding to the specific function may refer to a button that causes a request for the specific function to be transmitted from the user terminal to the server. In various embodiments of the present disclosure, the button corresponding to the specific function may also be represented as an entry point to the specific function. For example, a button corresponding to the message generation function may include the message generation button described above. The server stopping providing the specific function to the user terminal may include causing the user terminal to not display the button corresponding to the specific function.

According to an embodiment, the server may transmit, to the user terminal, a program (e.g., an app) including code that controls the display of the message generation button according to whether a text is present in the input box. The user terminal may control the display of the message generation button according to whether a text is present in the input box by installing and/or executing the program received from the server.

According to an embodiment, the server may transmit, to the user terminal, a signal (e.g., a display command or a display restriction command) that instructs whether to display the message generation button according to whether a text is present in the input box. The user terminal may control the display of the message generation button according to the signal received from the server.

The message generation system according to an embodiment may provide a text conversion function instead of the message generation function while a text is present in the input box. The message generation system may switch between the message generation function and the text conversion function based on whether a text is present in the input box.

The text conversion function may include a function of converting a text input to an input box according to a specified feature. The specified feature may include a speech and/or tone of a text. The speech and/or tone of a text may be expressed in terms of a character of a speaker and/or a sender. The text conversion function may include a function of converting a text input to an input box into a converted text having one feature selected from among a plurality of candidate features according to a user input. For example, the plurality of candidate features may include at least one of a speech of an emotional person, a speech of a polite person, a speech of a gentle person, a speech of a king character, or a speech of a subject character.

When the server provides the text conversion function to the user terminal, the user terminal may display a button corresponding to the text conversion function (hereinafter, a “text conversion button”). When the user terminal receives a user input for the text conversion button, a text conversion request may be transmitted to the server. When the text conversion request is received, the server may convert the text input to the input box into a converted text having a feature (e.g., a speech of gentle person) specified in the text conversion request. For example, the server may perform the text conversion using a text conversion model. The server may transmit information on the converted text obtained through the text conversion to the user terminal. The user terminal may replace the text input to the input box with the converted text.

In various embodiments of the present disclosure, it is described that the text conversion function of generating a converted text by using the text conversion model is mainly performed on the server, but embodiments are not limited thereto. For example, the user terminal may convert a text input to the input box into a converted text using the text conversion model in response to the user input for the text conversion button. The user terminal may replace the text input to the input box with the converted text.

The server may provide the user terminal with the text conversion function that converts the text input to the input box while the text is present in the input box of the chatroom.

The server may provide one function at a time by switching between the message generation function and the text conversion function according to whether a text is present in the input box of the chatroom. For example, the server may enable the text conversion function and disable the message generation function while a text is present in the input box. The server may disable the text conversion function and enable the message generation function while a text is not present in the input box.

Similar to the message generation function, the server may transmit, to the user terminal, a program (e.g., an app) including code that controls the display of the text conversion button according to whether a text is present in the input box. The user terminal may control the display of the text conversion button according to whether a text is present in the input box by installing and/or executing the program received from the server.

According to an embodiment, the server may transmit, to the user terminal, a signal (e.g., a display command or a display restriction command) that instructs whether to display the text conversion button according to whether a text is present in the input box. The user terminal may control the display of the text conversion button according to the signal received from the server.

The server may stop providing the text conversion function and resume providing the message generation function when the text is removed from the input box of the chatroom. The server may stop providing the text conversion function when all the text is removed from the input box of the chatroom (e.g., when there is no text in the input box of the chatroom). The server may resume providing the message generation function based on the text not being present in the input box of the chatroom.

Referring to FIG. 3, examples of an interface of the user terminal with the enabled message generation function are illustrated.

On a screen 301, the user terminal may display a chatroom screen. The screen 301 may include an input box 311, an additional menu expansion button 315, a message generation button 312, an emotion expression object selection button 313, and a search mode entry button 314. The additional menu expansion button 315 may refer to a button that provides a function of displaying an additional menu 318. The emotion expression object selection button 313 may refer to a button that provides a function of selecting an emotion expression object to be added to a message. The search mode entry button 314 may refer to a button that provides a function of transmitting, through a chatroom, a message including a search result obtained using a text input through the input box 311 as a search word. As shown in the screen 301, the message generation function may be enabled while there is no text in the input box 311, and the user terminal may display the message generation button 312.

When the user terminal receives a user input for an empty area (e.g., an area other than the message generation button 312) in the input box 311, the user terminal may display a screen 302. The screen 302 may be a screen on which a keyboard object 316 is displayed on the screen 301. The keyboard object 316 is an interfacing object for adding a text to the input box 311 and may include a virtual keyboard. As shown in the screen 302, the screen 302 may include the input box 311, the additional menu expansion button 315, the message generation button 312, the emotion expression object selection button 313, the search mode entry button 314, and the keyboard object 316. As shown in the screen 302, the message generation function may be enabled while there is no text in the input box 311, and the user terminal may display the message generation button 312.

The user terminal may display a screen 303 when a user input for the additional menu expansion button 315 is received. The screen 303 may refer to a screen in which the additional menu 318 is displayed on the screen 301 and the additional menu expansion button 315 is changed to an additional menu closing button 317. The additional menu closing button 317 may refer to a button that provides a function of stopping the display of the additional menu 318. As shown in the screen 303, the screen 303 may include the input box 311, the additional menu closing button 317, the message generation button 312, the emotion expression object selection button 313, the search mode entry button 314, and the additional menu 318. As shown in the screen 303, the message generation function may be enabled while there is no text in the input box 311, and the user terminal may display the message generation button 312.

When the user terminal stops the display of the additional menu 318 on the screen 303, the user terminal may display the screen 301 that does not include both the keyboard object 316 and the additional menu 318, or display the screen 302 that includes the keyboard object 316. The additional menu 318 may include buttons corresponding to items of the additional menu 318.

Referring to FIG. 4, examples of the interface of the user terminal with the disabled message generation function are illustrated.

On a screen 401, the user terminal may display a chatroom screen including an input box 411 in which a text is present. For example, the user terminal may add a text to the input box 411 based on a user input for a keyboard object (e.g., the keyboard object 316 of FIG. 3) in a screen (e.g., the screen 302 of FIG. 3) including the input box 411 in which a text is not present.

The user terminal may disable the message generation function and enable a text conversion button 412 based on the presence of the text in the input box 411. The user terminal may stop displaying a message generation button (e.g., the message generation button 312 of FIG. 3) and display the text conversion button 412. A screen 402 may include the input box 411, an additional menu expansion button 413, and the text conversion button 412.

On the screen 402 and a screen 403, the user terminal may display a chatroom screen to which a specific function is applied based on the text present in the input box 411.

On the screen 402, based on a trigger special character (e.g., “@”) of a mention function being input to the input box 411, the user terminal may display a chatroom screen to which the mention function is applied. For example, on a screen (e.g., the screen 302 of FIG. 3) including the input box 411 in which a text is not present, based on a user input for a keyboard object (e.g., the keyboard object 316 of FIG. 3), the user terminal may add the trigger special character of the mention function to the input box 411. The mention function may refer to a function to mention a specific user account among users (or user accounts) included in a chatroom within a message. The user terminal may disable the message generation function and enable the text conversion button 412 based on the presence of the text in the input box 411, even when the mention function is applied (or enabled). A screen 403 may include the input box 411, the additional menu expansion button 413, and the text conversion button 412, without including the message generation button.

On the screen 403, based on a trigger special character (e.g., “#”) of a keyword message function being input to the input box 411, the user terminal may display a chatroom screen to which the keyword message function is applied. For example, on a screen (e.g., the screen 302 of FIG. 3) including the input box 411 in which a text is not present, based on a user input for a keyboard object (e.g., the keyboard object 316 of FIG. 3), the user terminal may add the trigger special character of the keyword message function to the input box 411. The keyword message function may refer to a function that, when a message including the trigger special character and a search keyword (hereinafter, a “search keyword set”) of the keyword message function is transmitted, provides a search result for a keyword in response to a user input for the search keyword set of the transmitted message. The keyword message function may include a plurality of search keyword sets within a single message, and may include a function that provides a search result based on a keyword in each search keyword set in response to a user input for each search keyword set.

The user terminal may disable the message generation function and enable the text conversion button 412 based on the presence of the text in the input box 411, even when the keyword message function is applied (or enabled). A screen 403 may include the input box 411, the additional menu expansion button 413, and the text conversion button 412, without including the message generation button.

On a screen 404, the user terminal may display a chatroom screen that has entered a search mode. The mode of the chatroom screen may be set to one of a chat mode in which a message is input through the input box 411 and a search mode in which a search word is input through the input box 411. As described above with reference to FIG. 3, when a user input for a search mode entry button (e.g., the search mode entry button 314 of FIG. 3) is received, the user terminal may change the mode of the chatroom screen to the search mode that uses the text input through the input box 411 as a search word. The user terminal may disable both the message generation function and the text conversion button 412 when the mode of the chatroom screen is switched to the search mode. The message generation system according to an embodiment may interpret setting the mode of the chatroom screen to the search mode as an intent of the user to include a message including a search result, rather than directly writing a message, and may disable both the message generation function and the text conversion function that assist in writing a message.

The screen 404 may include the input box 411 and a search mode release button 414, without including the message generation button and the text conversion button 412. The search mode release button 414 may provide a function that switches the mode of the chatroom screen from the search mode to the chat mode. When the mode of the chatroom screen is switched to the chat mode, as described above, when a text is not present in the input box 411, the message generation function may be enabled and the text conversion function may be disabled, and when a text is present in the input box 411, the message generation function may be disabled and the text conversion function may be enabled.

FIG. 5 is a diagram illustrating an example of an operation of generating a candidate message by a message generation system according to various embodiments.

According to an embodiment, a server (e.g., the server 120 of FIG. 1) and/or a user terminal (e.g., the user terminal 110 of FIG. 1) of a message generation system (e.g., the message generation system 100 of FIG. 1) may provide a plurality of candidate messages.

According to an embodiment, the server may generate a plurality of candidate messages corresponding to a plurality of manners. A manner may include an attitude and/or a mood of a speaker and/or a sender. For example, the plurality of manners may include a positive attitude, a negative attitude, and a neutral attitude.

For example, for each of the plurality of manners, the server may obtain input data including a prompt corresponding to the manner and a source message. The server may generate the plurality of candidate messages corresponding to the plurality of manners by applying the message generating model to the obtained input data.

The prompt is at least a portion of the input data of the message generating model and may include a text describing a manner. For example, a prompt corresponding to a manner of a positive attitude may include, “Write with a positive attitude.” The server may generate the plurality of candidate messages corresponding to the plurality of manners by repeatedly applying the input data including the prompt corresponding to the manner and the source message to the message generating model.

The plurality of manners may be preset by a service provider of a message generation service or may be set as personalized manners by a user. According to an embodiment, at least one manner may be mapped to each chatroom. When the message generation request for a chatroom is received, the server may generate a candidate message for each of at least one manner mapped to the chatroom.

Referring to FIG. 5, on a screen 501, the user terminal may display a message generation button 511 based on the absence of text in the input box. The user terminal may receive a user input 512 for the message generation button 511. The user terminal may transmit the message generation request to the server. The server may receive the message generation request from the user terminal.

On a screen 502, the user terminal may display a guidance message 521 indicating that the generation of the candidate message is started in response to the message generation request. While the candidate message is being generated, the user terminal may replace the message generation button 511 with a graphical representation 522 indicating that a candidate message is being generated.

On a screen 503, when the generation of the candidate message is completed, the user terminal may display the generated candidate message. The user terminal may display the message generation button 511 again based on the completion of the generation of the candidate message. In FIG. 5, the candidate message may include the plurality of candidate messages corresponding to the plurality of manners. The user terminal may change a candidate message to be displayed, in response to a user input 532 (e.g., a swipe input) in an area corresponding to the candidate message.

On a screen 504, the user terminal may display a regeneration button 541 of the candidate message in response to the user input 532. As will be described in more detail below with reference to FIG. 6, the user terminal may request additional candidate messages in response to a user input for the regeneration button 541.

FIG. 6 is a diagram illustrating an example of an operation of regenerating a candidate message by a message generation system according to various embodiments.

According to an embodiment, a server (e.g., the server 120 of FIG. 1) and/or a user terminal (e.g., the user terminal 110 of FIG. 1) of a message generation system (e.g., the message generation system 100 of FIG. 1) may provide regeneration of a candidate message. The user may request regeneration of a candidate message if the generated candidate message is not satisfied. The message generation system may generate and/or provide an additional candidate message.

The server according to an embodiment may regenerate the candidate message by adjusting a set value of the message generating model. For example, when a regeneration request for at least one candidate message is received from the user terminal, the server may adjust the set value of the message generating model. The server may generate at least one additional candidate message from the source message using the message generating model with the adjusted set value.

The set value of the message generating model may include a value of the a parameter (or hyperparameter) of the message generating model. For example, the set value of the message generating model may include a value of a temperature of the message generating model. The temperature may refer to a hyperparameter that controls the randomness of a response of the message generating model. For example, as the value of the temperature is large, an output of the message generating model may be more unpredictable and/or creative. In contrast, as the value of the temperature is small, the output of the message generating model may be more common and/or conservative.

Referring to FIG. 6, on a screen 601 (e.g., the screen 504 of FIG. 5), the user terminal may display at least a portion of the candidate message and a regeneration button 611 (e.g., the regeneration button 541 of FIG. 5). When a user input 612 of selecting the regeneration button 611 is received, the user terminal may transmit a regeneration request for a candidate message to the server. When the regeneration request for the candidate message is received, the server may adjust the set value of the message generating model.

After adjusting the set value of the message generating model, the server may generate the candidate message (e.g., the additional candidate message) in the same or similar manner as in the case where the message generation request is received, and/or may transmit information on the candidate message (e.g., the additional candidate message) to the user terminal, and the user terminal may, when the information on the additional candidate message is received, operate in the same or similar manner as in the case where the information on the candidate message is received.

On a screen 602, similarly to the screen 502 of FIG. 5, the user terminal may display a guidance message indicating that the generation of the additional candidate message is started in response to the regeneration request.

On a screen 603, similarly to the screen 503 of FIG. 5, the user terminal may display the generated additional candidate message when the generation of the additional candidate message is completed. The user terminal may change a candidate message to be displayed, in response to a user input 632 (e.g., a swipe input) in an area corresponding to the additional candidate message.

On a screen 604, similarly to the screen 504 of FIG. 5, the user terminal may display a regeneration button 641 of the candidate message in response to the user input 632. The user terminal may repeatedly (e.g., three or more times) request the generation of the candidate message by displaying the regeneration button 641 of the candidate message again.

Although not explicitly shown in FIG. 6, the user terminal may obtain a regeneration request for specifying one candidate message from among the plurality of candidate messages. For example, the user terminal may display the regeneration button corresponding to each candidate message. When the plurality of candidate messages is generated, the user terminal may display a plurality of regeneration buttons respectfully corresponding to the plurality of candidate messages. When a user input for one of the plurality of regeneration buttons is received, the user terminal may transmit, to the server, the regeneration request for specifying the candidate message to which the regeneration button corresponds. The server may generate the additional candidate message having a manner of the specified candidate message. The number of additional candidate messages having the manner of the specified candidate message may be one, but is not limited thereto, and a plurality of candidate messages may be generated.

FIG. 7 is a diagram illustrating an example of an operation of transmitting a message based on a candidate message by a message generation system according to various embodiments.

According to an embodiment, a server (e.g., the server 120 of FIG. 1) and/or a user terminal (e.g., the user terminal 110 of FIG. 1) of a message generation system (e.g., the message generation system 100 of FIG. 1) may provide transmission of a message based on a candidate message 711 when the candidate message 711 is selected.

Referring to FIG. 7, on a screen 701, the user terminal may display at least one candidate message together with a message generation button 713 based on the absence of a text in an input box 714. The user terminal may receive a user input 712 of selecting a candidate message 711 (hereinafter, referred to as a selected candidate message 711) from among the at least one candidate message.

On a screen 702, the user terminal may add a text corresponding to the selected candidate message 711 to the input box 714 in response to the user input 712 of selecting the selected candidate message 711. The user terminal may disable the message generation function and enable the text conversion function based on the presence of the text in the input box 714. The user terminal may stop displaying the message generation button 713 and display a text conversion button 723.

The user terminal may write a message in which at least a portion of the text of the selected candidate message 711 is modified or an emotion expression object is added to the selected candidate message 711.

For example, the user terminal may write the message in which at least a portion of the text of the selected candidate message 711 is modified based on a user input 722 obtained through a keyboard object. Referring to FIG. 7, on the screen 702 and a screen 703, the user terminal may modify a text of the selected candidate message 711 (e.g., “Happy New Year.”) to a modified text (e.g., “Happy New Year to all.”) based on a user input 721.

For example, the user terminal may write the message in which at least a portion of the text of the selected candidate message 711 is modified through the text conversion function. Referring to FIG. 7, on the screen 702, the user terminal may receive the user input 722 for the text conversion button 723. On a screen 705, the user terminal may display buttons 751 corresponding to a plurality of candidate features (e.g., the speech of an emotional person, the speech of a polite person, and the speech of a gentle person) according to the text conversion function provided. Although not explicitly shown in FIG. 7, when a user input (not shown) of selecting a button corresponding to the speech of a polite person is received, the user terminal may modify a text input to the input box 714 (e.g., a text of the selected candidate message 711) into a converted text having the speech of a polite person (e.g., “Wishing you a happy new year.”).

Although not explicitly shown in FIG. 7, when a user input for an emotion expression object selection button is received, the user terminal may display a list of available emotion expression objects to the user terminal or user account. The user terminal may, in response to a user input of selecting at least one of the emotion expression objects, write a message including a result of adding the selected emotion expression object to the text input to the input box 714 (e.g., the text of the selected candidate message 711).

The user terminal may transmit a transmission request for a message written based on the selected candidate message 711 to the server. Referring to FIG. 7, for example, on the screen 703, the user terminal may transmit the transmission request for the message to the server based on a user input 731 for a transmission button being received.

The server may receive, from the user terminal, a transmission request for a message in which at least a portion of the text of the selected candidate message 711 is modified or an emotion expression object is added to the selected candidate message 711. The server may transmit the message based on the selected candidate message 711 to other user terminals of other user accounts participating in the chatroom. Referring to FIG. 7, on a screen 704, based on the message being transmitted, the user terminal may display the message based on the selected candidate message 711 as one of the messages transmitted in the chatroom. The user terminal may disable the text conversion function and enable the message generation function when a text input to the input box 714 is not present according to the transmission of the message.

FIG. 8 is a diagram illustrating an example of an operation of stopping generation of a candidate message according to a text input by a message generation system according to various embodiments.

According to an embodiment, a server (e.g., the server 120 of FIG. 1) and/or a user terminal (e.g., the user terminal 110 of FIG. 1) of a message generation system (e.g., the message generation system 100 of FIG. 1) may stop the generation of a candidate message, when a text input of an input box is obtained while the candidate message is being generated.

Referring to FIG. 8, on a screen 801, the user terminal may enable the message generation function and display a message generation button 811 while a text is not present in the input box. As described above, the user terminal may disable the text conversion function and not display a text conversion button 831 while a text is not present in the input box. In response to a user input for the message generation button 811, the generation of the candidate message may be started.

On a screen 802, the user terminal may display a guidance message indicating that the generation of the candidate message is started, based on that the generation of the candidate message is started. The user terminal may receive a text input 822 of the input box while the candidate message is being generated (e.g., after the generation of the candidate message is started but before the generation of the candidate message is completed). The text input 822 may include a user input for a keyboard object 821. As described above, in response to the text input 822, the generation of the candidate messages may be stopped.

On a screen 803, the user terminal may stop displaying the guidance message indicating that the generation of candidate messages is started in response to the generation of the candidate message being stopped. The user terminal may disable the message generation function and enable the text conversion function based on a text added to the input box according to the text input. The user terminal may stop displaying the message generation button 811 and display the text conversion button 831.

FIG. 9 is a diagram illustrating an example of an operation of stopping generation of a candidate message according to stopping display of a keyboard object by a message generation system according to various embodiments.

According to an embodiment, a server (e.g., the server 120 of FIG. 1) and/or a user terminal (e.g., the user terminal 110 of FIG. 1) of a message generation system (e.g., the message generation system 100 of FIG. 1) may stop the generation of a candidate message, when information on stopping display of a keyboard object is obtained while the candidate message is being generated.

When the information on the stopping of the display of the keyboard object for adding a text to the input box of the chatroom is received from the user terminal before the generation of the candidate message is completed, the server may stop the generation of the candidate message. For example, the user terminal may stop the display of the keyboard object based on a user input obtained when the keyboard object is displayed.

Referring to FIG. 9, on a screen 901, the user terminal may display a guidance message indicating that the generation of the candidate message is started along with the keyboard object, based on that the generation of the candidate message is started. The screen 901 may include a keyboard object 911, an additional menu expansion button 912, and a back button 914.

The user terminal may receive a user input of causing the stopping of the display of the keyboard object while generating the candidate message (e.g., after the generation of the candidate message is started but before the generation of the candidate message is completed). For example, the user input of causing the stopping of the display of the keyboard object may include a user input 913 for the additional menu expansion button and/or a user input 915 for the back button.

On a screen 902, the user terminal may stop displaying the keyboard object in response to the user input 915 for the back button on the screen 901. In response to the user input 915 and/or the stopping of the display of the keyboard object, the user terminal may transmit information on the stopping of the display of the keyboard object to the server. The server may stop generating the candidate message. In response to the stopping of the generation of the candidate message, the user terminal may stop displaying the guidance message guiding that the candidate message is being generated.

On a screen 903, the user terminal may stop displaying the keyboard object in response to the user input 913 for the additional menu expansion button on the screen 901. The user terminal may display an additional menu instead of the keyboard object. Similar to the description provided above for the screen 902, in response to the user input 913 and/or the stopping of the display of the keyboard object, the user terminal may transmit the information on the stopping of the display of the keyboard object to the server. The server may stop generating the candidate message. In response to the stopping of the generation of the candidate message, the user terminal may stop displaying the guidance message guiding that the candidate message is being generated.

As shown in FIG. 9, when the generation of the candidate message is stopped based on the stopping of the display of the keyboard object, a text is not added to the input box, and thus, the enabling of the message generation function and/or the disabling of the text conversion function may be maintained. On the other hand, as described above with reference to FIG. 8, when the generation of candidate message is stopped based on the text input to the input box, a text is added to the input box, and thus, the enabling of the message generation function and the disabling of the text conversion function may be changed to the disabling of the message generation function and the enabling of the text conversion function.

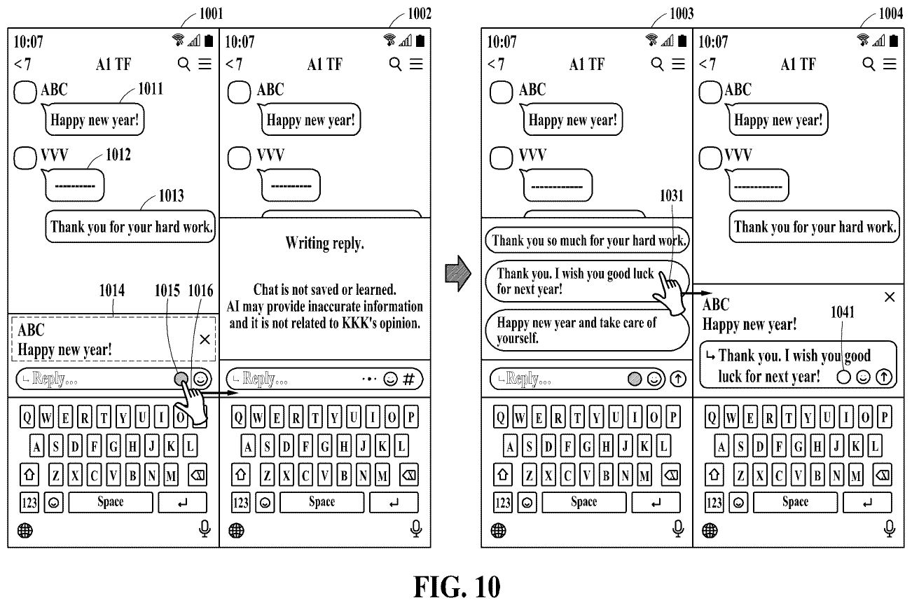

FIG. 10 is a diagram illustrating an example of an operation of generating a candidate message for a response to a target message by a message generation system according to various embodiments.

According to an embodiment, a server (e.g., the server 120 of FIG. 1) and/or a user terminal (e.g., the user terminal 110 of FIG. 1) of a message generation system (e.g., the message generation system 100 of FIG. 1) may provide the generation of a candidate message for a response to a target message.

The server may receive a message generation request requesting a response to a specified target message among the messages transmitted and received through the chatroom. The target message may refer to a message selected as the target of a reply among the transmitted and received messages. The message generation request may include information on the target message.

The server may input a source message and the target message to the message generating model. The message generating model may additionally receive the information on the target message when the candidate messages is generated as a draft of the response to the target message. For example, the information on the target message may include the target message, and/or a relationship between each source message and the target message (e.g., a difference between transmitted times or whether the messages are transmitted by the same user).

According to an embodiment, the server may select, as the source message, at least one message transmitted or received through the chatroom prior to the target message, based on the target message. For example, the server may select, as the source messages, messages transmitted a predetermined length of time (e.g., 3 days) prior to the transmission time of the target message. The server according to an embodiment may generate the candidate message by considering the conversation context before the target message is transmitted or received, by selecting, as the source message, at least one message transmitted or received in the chatroom before the target message.

However, in various embodiments of the present disclosure, it is mainly described that the server generates the response to the target message based on the target message and the source message selected as a message other than the target message, but embodiments are not limited thereto. For example, the server may generate the candidate message as a draft of the response to the target message by selecting only the target message as the source message (e.g., the target message and the source message are the same) and inputting the target message to the message generating model.

Referring to FIG. 10, on a screen 1001, the user terminal may display messages (e.g., a first message, a second message, and a third message) transmitted and received through a chatroom. The user terminal may obtain a user input of specifying the first message as the target message. The user terminal may, in response to the user input, display information on the first message in an area 1014 corresponding to the input box. The user terminal may enable the message generation function and display a message generation button 1015 based on the absence of a text in the input box. The user terminal may obtain a user input 1016 of selecting the message generation button 1015.

On a screen 1002, the user terminal may transmit a message generation request to the server based on the user input 1016 for the message generation button 1015. The server may start the generation of the candidate message in response to the message generation request. Based on that the generation of the candidate message is started, the user terminal may display a guidance message indicating that the generation of the candidate message is started and/or the candidate message is being generated.

On a screen 1003, based on that the generation of the candidate message is completed, the user terminal may display the candidate message. The user terminal may add a text of the candidate message to the input box based on receiving a user input 1031 of selecting the candidate message.

On a screen 1004, the user terminal may add the text of the candidate message to the input box as a draft of the response to the target message. As described above with reference to FIG. 7, the user terminal may write a message based on the candidate message by modifying at least a portion of the text of the candidate message or adding an emotion expression object to the candidate message. The user terminal may disable the message generation function and stop the display of the message generation button 1015 based on the presence of the text of the candidate message in the input box. The user terminal may enable the text conversion function and display a text conversion button 1041.

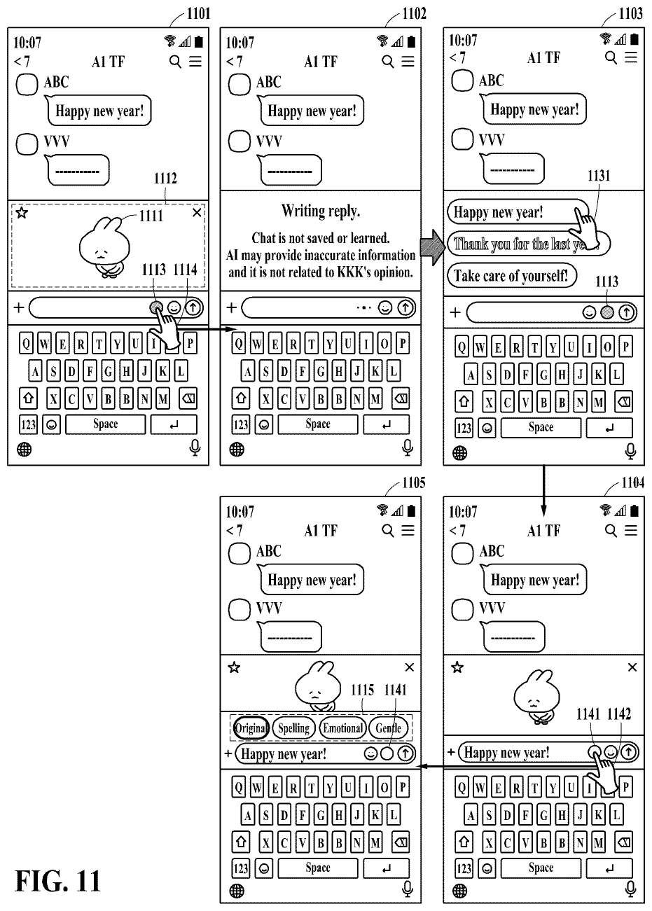

FIG. 11 is a diagram illustrating an example of an operation of generating a candidate message subsequent to selection of an emotion expression object by a message generation system according to various embodiments.

According to an embodiment, a server (e.g., the server 120 of FIG. 1) and/or a user terminal (e.g., the user terminal 110 of FIG. 1) of a message generation system (e.g., the message generation system 100 of FIG. 1) may generate a candidate message including a text to be transmitted together with an emotion expression object 1111, the text being selected subsequent to the selection of the emotion expression object 1111.

The user terminal may select the emotion expression object 1111 from among candidate emotion expression objects. Referring to FIG. 11, on a screen 1101, the user terminal may display the selected emotion expression object 1111 in an emotion expression object preview area 1112 in response to a user input of selecting the emotion expression object. According to an embodiment, the emotion expression object preview area 1112 may be distinguished as a separate area from the input box, and a state in which a text is not present in the input box may be maintained even if the emotion expression object 1111 is selected. Accordingly, on the screen 1101, the user terminal may enable the message generation function and display a message generation button 1113 based on the absence of a text in the input box. The user terminal may transmit a message generation request to the server based on a user input 1114 for the message generation button 1113.

The server may receive, from the user terminal, the message generation request requesting the generation of a text to be transmitted together with the emotion expression object 1111 selected from among the candidate emotion expression objects.

According to an embodiment, the message generation request may include information related to the selected emotion expression object 1111. The server may generate candidate messages using the information related to the selected emotion expression object 1111. For example, the selected emotion expression object 1111 may be mapped to at least one manner. The server may generate a candidate message corresponding to the at least one manner to which the selected emotion expression object 1111 is mapped.

On a screen 1102, the server may start the generation of the candidate message in response to the message generation request. Based on that the generation of the candidate message is started, the user terminal may display a guidance message indicating that the generation of the candidate message is started and/or the candidate message is being generated. As shown on the screen 1102, a guidance message may be displayed to replace and/or cover the emotion expression object preview area 1112, but is not limited thereto. For example, the display of the guidance message may be performed in a different area from the emotion expression object preview area 1112 simultaneously with the display of the selected emotion expression object 1111.

On a screen 1103, based on that the generation of the candidate message is completed, the user terminal may display the candidate message. The user terminal may add a text of the candidate message to the input box based on receiving a user input 1131 of selecting the candidate message. As shown on the screen 1103, the candidate messages may be displayed to replace and/or cover the emotion expression object preview area 1112, but is not limited thereto. For example, the display of the candidate messages may be performed in a different area from the emotion expression object preview area 1112 simultaneously with the display of the selected emotion expression object 1111.

On a screen 1104, the user terminal may add the candidate message (or the text of the candidate message) to the input box as the text to be transmitted together with the selected emotion expression object 1111. As described above with reference to FIG. 7, the user terminal may write a message based on the candidate message by modifying at least a portion of the text of the candidate message. The user terminal may disable the message generation function and stop the display of the message generation button based on the presence of the text of the candidate message in the input box. The user terminal may enable the text conversion function and display a text conversion button 1141.

On a screen 1105, the user terminal may display buttons 1151 for the text conversion function based on receiving a user input 1142 for the text conversion button 1141.

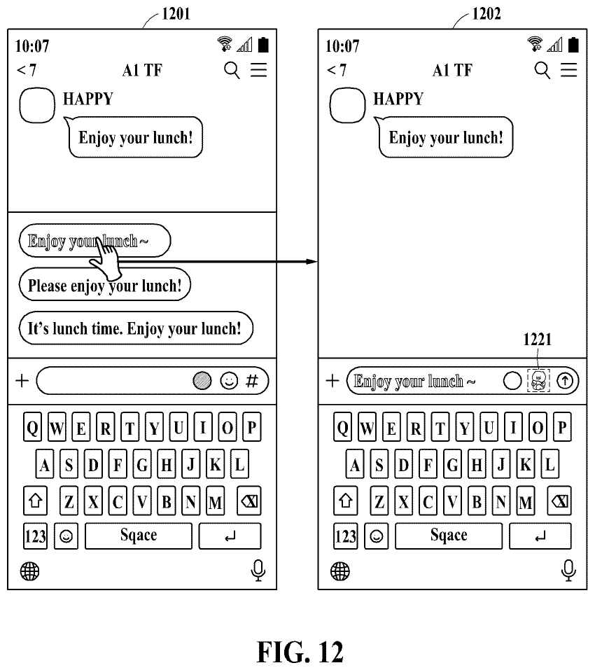

FIG. 12 illustrates an example of an operation of providing a recommended emotion expression object according to selection of a candidate message by a message generation system according to various embodiments.

According to an embodiment, a server (e.g., the server 120 of FIG. 1) and/or a user terminal (e.g., the user terminal 110 of FIG. 1) of a message generation system (e.g., the message generation system 100 of FIG. 1) may select a recommended emotion expression object when the candidate message is input to the input box according to the selection of the candidate message.

When information on a user input of selecting the candidate message selected from among the at least one candidate message is received, the server may select a recommended emotion expression object based on the candidate message from among candidate emotion expression objects. On a screen 1201, the user terminal may display at least one candidate message as a result of the message generation function. The user terminal may receive a user input 1211 of selecting the selected candidate message. The user terminal may input the selected candidate message (or the text of the selected candidate message) to the input box in response to the user input 1211 of selecting the selected candidate message. The user terminal may transmit, to the server, information on the user input 1211 and/or information on the text input to the input box. The server may select the recommended emotion expression object from among a plurality of candidate emotion expression objects based on the text input to the input box (e.g., the selected candidate message or the text of the selected candidate message). For example, the candidate emotion expression object may be mapped to at least one keyword. When a keyword is received from a text, the server may select the candidate emotion expression object to which each keyword is mapped, as the recommended emotion expression object.

The server may transmit information on the selected recommended emotion expression object to the user terminal. When the information on the selected recommended emotion expression object is received from the server, the user terminal may display the recommended emotion expression object and/or a graphical representation of the recommended emotion expression object. On a screen 1202, the user terminal may display a preview 1221 of the recommended emotion expression object in the input box.

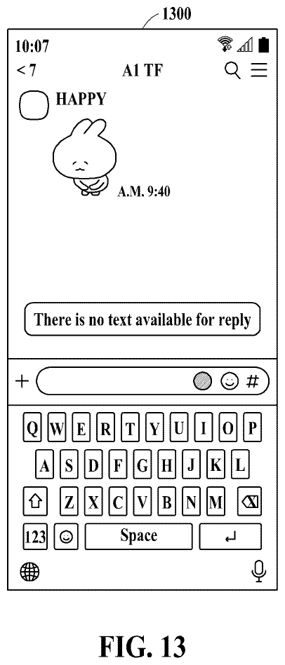

FIG. 13 is a diagram illustrating an example of a guidance message guiding that a candidate message may not be generated in response to a message generation request by a message generation system.

The message generation system according to an embodiment may select a source message from among messages transmitted and received through a chatroom. The message generation system may generate candidate messages based on the source message. When there is no message selectable as the source message, the message generation system may display a guidance message guiding that the candidate message may not be generated, and may not perform the generation of the candidate message.

For example, the message generation system may select a message including a text as the source message. The message generation system may not select, as the source message, a message that does not include a text (e.g., a message including only an image or a message including only an emotion expression object). When there is no message including a text among the messages transmitted and received through the chatroom, the message generation system may provide a guidance message guiding that the generation of the candidate message is impossible due to the absence of the message including a text. Referring to FIG. 13, on a screen 1300, the user terminal may display a guidance message (e.g., “There is no text available for a reply.”).

For example, the message generation system may select the source message from among recent messages. The message generation system may select, as the source message, a message transmitted within a specific period (e.g., one month) from the time of the message generation request. The message generation system may not select, as the source message, a message transmitted before a specific period (e.g., one month) from the time of the message generation request. When there is no message transmitted within the specific period among the messages transmitted through the chatroom, the message generation system may provide a guidance message guiding that the generation of the candidate messages is impossible due to the absence of messages transmitted within the specific period. Although not explicitly shown in FIG. 13, the user terminal may display a guidance message (e.g., “There are no chats within the last month.”).

The state of the message generation system according to an embodiment may be a state in which the generation of the candidate message is impossible due to a communication error regarding a network (e.g., the network 130 of FIG. 1). When the message generation system is in the state in which the generation of the candidate message is impossible due to the communication error regarding the network, the message generation system may provide a guidance message guiding that the generation of the candidate message is impossible due to the network-related problem. Although not explicitly shown in FIG. 13, the user terminal may display a guidance message (e.g., “Network connection is poor.”).

The state of the message generation system according to an embodiment may be a state in which the generation of the candidate message is impossible due to an error of a server (e.g., the server 120 of FIG. 1). When the message generation system is in the state in which the generation of the candidate message is impossible due to the error of the server, the message generation system may provide a guidance message guiding that the generation of the candidate message is impossible due to the server-related problem. Although not explicitly shown in FIG. 13, the user terminal may display a guidance message (e.g., “A temporary error has occurred.”).

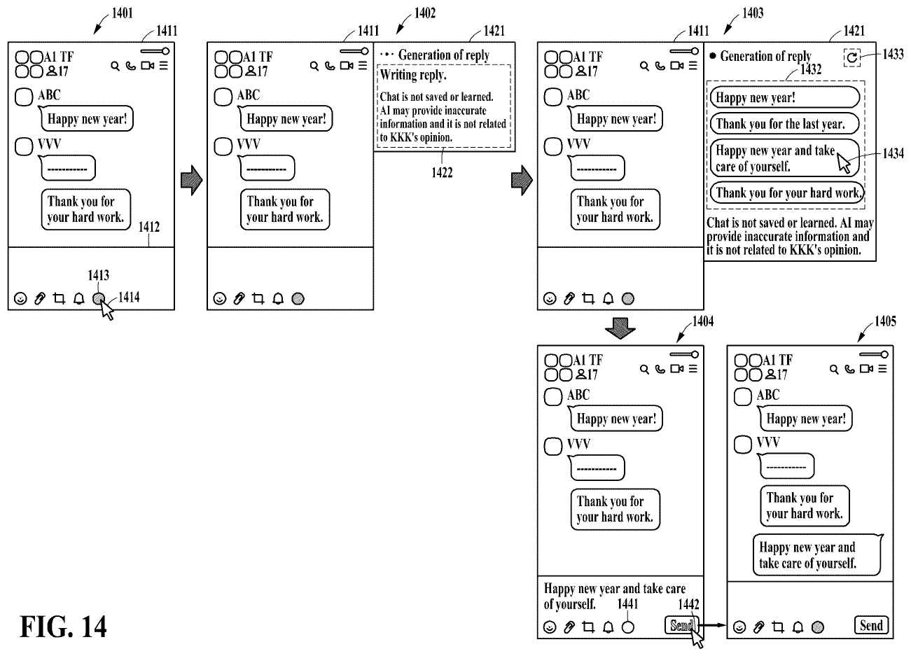

FIG. 14 is a diagram illustrating examples of a UI provided on a user terminal of a message generation system according to various embodiments.

The message generation system according to an embodiment may provide a UI of a mode corresponding to a category of the user terminal among UIs of a plurality of modes according to the category of the user terminal. For example, the category of the user terminal may be one of mobile or personal computer (PC). A first mode corresponding to the mobile may be referred to as a “mobile mode,” and a second mode corresponding to the PC may be referred to as a “PC mode.”

The example screens of the UI described above with reference to FIGS. 3 to 13 may be UIs in the mobile mode. Hereinafter, example screens of the UI in the PC mode will be described with reference to FIG. 14.

On a screen 1401, the user terminal may display a chatroom screen through a first window 1411. The chatroom screen may include an input box 1412 and a message generation button 1413. The user terminal may, as described above, enable the message generation function and display the message generation button 1413 and/or disable the text conversion function and not display a text conversion button 1441 based on the absence of a text in the input box 1412. The user terminal may transmit a message generation request to the server in response to a user input 1414 (e.g., a click input) for the message generation button 1413. The server may start generating the candidate message.

On a screen 1402, the user terminal may display the chatroom screen through the first window 1411 and a guidance message 1422 through a second window 1421 based on the starting of the generation of the candidate message. The guidance message 1422 may include a message guiding that the candidate message is being generated and/or that the generation of the candidate message is started. As described above, the server may stop the generation of the candidate message based on a user input at a time point during the generation of the candidate message (e.g., at a time point after the generation of the candidate message starts and before the generation of the candidate messages is completed). The user input may include a text input (e.g., a user input of adding a text) of the input box 1412 and/or a user input (e.g., a click input) for an area outside the second window 1421. The server may transmit information on the candidate message to the user terminal when information on the user input (e.g., the text input or the user input for the area outside the second window 1421) is not received from the user terminal until the generation of the candidate message is completed.

On a screen 1403, the user terminal may display the chatroom screen through the first window 1411 and a candidate message 1432 through the second window 1421. The screen of the second window 1421 may include the candidate message 1432 and a regeneration button 1433. As described above with reference to FIG. 6, the user terminal may request for the regeneration of the candidate message through the regeneration button 1433.

On a screen 1404, the user terminal may add a selected candidate message to the input box in response to a user input 1434 of selecting the candidate message. The user terminal may disable the message generation function and stop displaying the message generation button 1413 based on the presence of the text in the input box. The user terminal may enable the text conversion function and display the text conversion button 1441 based on the presence of the text in the input box.

As described above with reference to FIG. 7, the user terminal may write a message based on the candidate message by modifying at least a portion of the text of the candidate message or adding an emotion expression object to the candidate message. The user terminal may transmit a message transmission request to the server in response to a user input 1442 for a transmission button.

On a screen 1405, based on the message being transmitted, the user terminal may display the message based on the candidate message as one of the messages transmitted in the chatroom. When there is no text input to the input box according to the transmission of the message, the user terminal may disable the text conversion function (e.g., stop displaying the text conversion button) and enable the message generation function (e.g., display the message generation button).

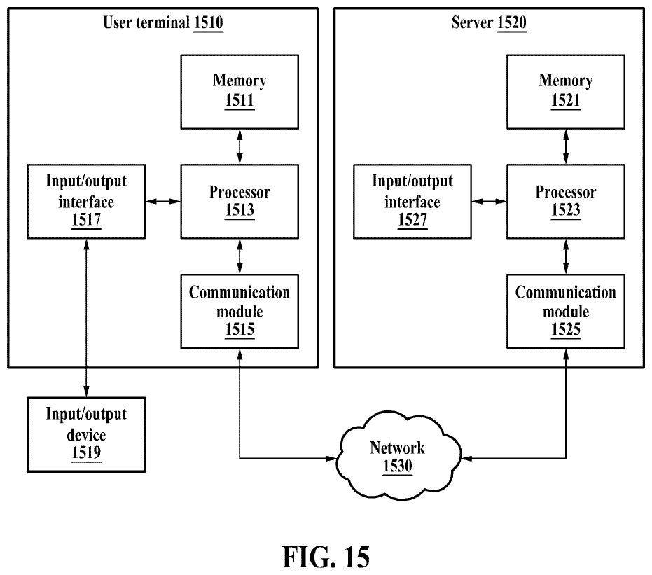

FIG. 15 is a diagram illustrating an example of a hardware configuration of a system for a message generation service according to an embodiment.

Referring to FIG. 15, a system for a message generation service (e.g., the message generation system 100 of FIG. 1) according to an embodiment may include a user terminal 1510 (e.g., the user terminal 110 of FIG. 1) and a server 1520 (e.g., the server 120 of FIG. 1) connected via a network 1530 (e.g., the network 130 of FIG. 1).

The user terminal 1510 may be a mobile terminal implemented as a computer device. For example, the user terminal 1510 may communicate with the server 1520 and/or other electronic devices (e.g., other user terminals or other servers) via the network 1530 using a wireless communication method and/or a wired communication method.

The server 1520 may be implemented as one or more computer devices providing commands, code, files, content, services, and the like by communicating with the user terminal 1510 and/or another server through the network 1530. The communication scheme is not limited, and may include a communication scheme using a communication network (e.g., a mobile communication network, wired Internet, wireless Internet, and a broadcasting network) that may be included in the network 1530 and a short-range wireless communication scheme between devices. For example, the network 1530 may include one or more networks among networks, such as a personal area network (PAN), a local area network (LAN), a campus area network (CAN), a metropolitan area network (MAN), a wide area network (WAN), a broadband network (BBN), the Internet, and the like.

According to an embodiment, the server 1520 may provide a file for installing an app to the user terminal 1510 accessing the server 1520 through the network 1530. In this case, the user terminal 1510 may install an app (e.g., an app related to a message generation service) using a file provided by the server 1520. In addition, by control of an operating system (OS) and at least one program (e.g., a browser or an installed application), the user terminal 1510 may access the server 1520 and receive a service or content provided by the server 1520. For example, when the user terminal 1510 transmits a request for a service to the server 1520 through the network 1530 by control of the application, the server 1520 may transmit code corresponding to the request to the user terminal 1510, and the user terminal 1510 may provide content to a user by forming and displaying a screen according to the code by control of the application.

According to an embodiment, the user terminal 1510 may include a memory 1511, a processor 1513, a communication module 1515, and an input/output interface 1517. The server 1520 may include a memory 1521, a processor 1523, a communication module 1525, and an input/output interface 1527.

The processors 1513 and 1523 according to an embodiment may perform at least one operation related to the message generation service described above with reference to FIGS. 1 to 14. For example, the processor 1513 may perform at least one operation of the user terminal 1510 performed on an app or web related to the message generation service described above with reference to FIGS. 1 to 14, and the processor 1523 may perform at least one operation of the server 1520 for providing the social media service described above with reference to FIGS. 1 to 14. The processors 1513 and 1523 may be configured to process commands of a computer program by performing basic arithmetic, logic, and input/output operations. The commands may be provided to the processors 1513 and 1523 by the memories 1511 and 1521 or the communication modules 1515 and 1525.

The memories 1511 and 1521 may be a computer-readable storage medium, which may be volatile or non-volatile memory. The memories 1511 and 1521 may store information for running an app or web for the message generation service described above with reference to FIGS. 1 to 14.

The memory 1511 may include code for an app related to the message generation service installed and running on the user terminal 1510 by files provided by the server 1520 through the network 1530.

The memory 1521 may store a program implementing operations for the message generation service described above with reference to FIGS. 1 to 14.

The communication modules 1515 and 1525 may provide a function for the user terminal 1510 and the server 1520 to communicate with each other through the network 1530 and a function for the user terminal 1510 and the server 1520 to communicate with another electronic device or another server through the network 1530.

For example, a request generated by the processor 1513 of the user terminal 1510 according to program code of an app related to the message generation service stored in a recording device, such as the memory 1511, may be transmitted to the server 1520 through the network 1530 by control of the communication module 1515.

For example, control signals, commands, content, files, and the like provided by control of the processor 1523 of the server 1520 may be received by the user terminal 1510 through the communication module 1515 of the user terminal 1510 after passing through the communication module 1525 and the network 1530.

The input/output interfaces 1517 and 1527 may be an interface with an input/output device 1519. For example, an input device may include a device, such as a keyboard or a mouse, and an output device may include a device, such as a display for displaying a communication session of an application. In another example, the input/output interface 1517 may be interface with a device having input and output functions, such as a touch screen. Specifically, for example, when the processor 1513 of the user terminal 1510 processes commands of a computer program loaded in the memory 1511, content or a service screen formed by using data provided by the server 1520 may be displayed on a display through the input/output interface 1517. For example, at least one interface screen described above with reference to FIGS. 1 to 14 may be displayed on a display through the input/output interface 1517. An input received from a user through the input/output device 1519 may be provided in a form processable by the processor 1513 of the user terminal 1510 through the input/output interface 1517.

According to an embodiment, the user terminal 1510 and the server 1520 may include other components than the illustrated ones in FIG. 15. For example, the user terminal 1510 may be implemented to include at least a portion of the input/output device 1519 described above or may further include other components, such as transceivers, global positioning system (GPS) modules, cameras, various types of sensors, databases, and the like.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an OS and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

In various embodiments, the user terminal may detect whether a user has added a text to the input box or has stopped displaying the keyboard object. The terminal transmits this information to the server while the candidate message is being generated. If the server determines that the candidate message has not yet been completed, the server stops the generation process. This real-time control mechanism reduces the consumption of computing resources and network bandwidth, preventing the generation and delivery of candidate messages that are no longer relevant. By adapting to user behavior dynamically, the system enhances efficiency and responsiveness compared to conventional systems that perform message generation in a static or unconditional manner.

Furthermore, the method includes a mechanism for improving system efficiency by selectively halting candidate message generation when a user input is detected during the generation process. When the user terminal detects input activity, such as text entry into the input box or dismissal of the on-screen keyboard, it transmits corresponding information to the server. If the candidate message has not yet been completed, the server stops the generation process. This functionality conserves computing resources, reduces unnecessary data transmission, and provides a more responsive user experience, especially in mobile environments where latency and resource constraints are more pronounced.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by a server, the method comprising:
receiving a message generation request from a user terminal;
starting generation of at least one candidate message by inputting a source message to a message generating model;
when information on a text input of an input box is received from the user terminal before the generation of the at least one candidate message is completed, stopping the generation of the at least one candidate message; and
when the information on the text input of the input box is not received from the user terminal until the generation of the at least one candidate message is completed, transmitting information on the generated at least one candidate message to the user terminal.

2. The method of claim 1, wherein the text input comprises a user input of adding a text to the input box in which a text is not input.

3. The method of claim 1, further comprising:
for each of a plurality of manners, obtaining input data comprising a prompt corresponding to a corresponding manner, and the source message; and
generating a plurality of candidate messages corresponding to the plurality of manners by applying the message generating model to the obtained input data.

4. The method of claim 1, further comprising:
when a re-generation request for the at least one candidate message is received from the user terminal, adjusting a set value of the message generating model; and
generating at least one additional candidate message from the source message using the message generating model having the adjusted set value.

5. The method of claim 1, further comprising:
when information on stopping displaying a keyboard object for adding a text to the input box is received from the user terminal before the generation of the at least one candidate message is completed, stopping the generation of the at least one candidate message.

6. The method of claim 1, further comprising:
receiving, from the user terminal, a transmission request for a message obtained by modifying at least a portion of a text of a candidate message selected from among the at least one candidate message or adding an emotion expression object to the selected candidate message; and
transmitting the message based on the selected candidate message to another user terminal of another user account.

7. The method of claim 1, wherein
the receiving of the message generation request comprises receiving the message generation request of requesting for a response to a target message, and
the starting of the generation of the at least one candidate message comprises inputting the source message and the target message to the message generating model.

8. The method of claim 1, wherein the receiving of the message generation request comprises receiving, from the user terminal, the message generation request of requesting for generation of a text to be transmitted together with an emotion expression object selected from among candidate emotion expression objects.

9. The method of claim 1, further comprising:
when information on a user input of selecting a candidate message from among the at least one candidate message is received, selecting a recommended emotion expression object based on the selected candidate message; and
transmitting information on the selected recommended emotion expression object to the user terminal.

10. The method of claim 1, further comprising:
while a text is not present in the input box, providing the user terminal with a message generation function of generating the at least one candidate message; and
when a text is added to the input box, stopping providing the message generation function.

11. The method of claim 10, further comprising:
while a text is present in the input box, providing the user terminal with a text conversion function of converting a text input to the input box; and
when the text is removed from the input box, stopping providing the text conversion function and resuming providing the message generation function.

12. A non-transitory computer-readable storage medium storing instructions that, when executed by a processor, cause the processor to perform the method of claim 1.

13. A server comprising:
one or more processors; and
a memory configured to store instructions,
wherein the instructions, when executed by the one or more processors, cause the server to:
receive a message generation request from a user terminal;
start generation of at least one candidate message by inputting a source message to a message generating model;
when information on a text input of an input box is received from the user terminal before the generation of the at least one candidate message is completed, stop the generation of the at least one candidate message; and
when the information on the text input of the input box is not received from the user terminal until the generation of the at least one candidate message is completed, transmit information on the generated at least one candidate message to the user terminal.

14. A method performed by a user terminal, the method comprising:
obtaining a message generation request;
starting generation of at least one candidate message by inputting a source message to a message generating model in response to the obtained message generation request;
based on the generation of at least one candidate message being started, displaying a screen indicating that the generation of the at least one candidate message is started;
when information on a text input of an input box is received before the at least one candidate message is displayed, stopping displaying the screen indicating that the generation of the at least one candidate message is started; and
when the information on the text input of the input box is not received before the at least one candidate message is displayed, displaying the at least one candidate message.

15. A user terminal comprising:
one or more processors; and
a memory configured to store instructions,
wherein the instructions, when executed by the one or more processors, cause the user terminal to:
obtain a message generation request;
start generation of at least one candidate message by inputting a source message to a message generating model in response to the obtained message generation request;
based on the generation of at least one candidate message being started, display a screen indicating that the generation of the at least one candidate message is started;
when information on a text input of an input box is received before the at least one candidate message is displayed, stop displaying the screen indicating that the generation of the at least one candidate message is started; and
when the information on the text input of the input box is not received before displaying the at least one candidate message, display the at least one candidate message.

16. The method of claim 1, wherein stopping the generation of the at least one candidate message comprises interrupting inference processing by the message generating model based on a signal from the user terminal.

17. The method of claim 1, wherein stopping the generation of the at least one candidate message comprises:
omitting transmission of data representing incomplete or unrequested candidate messages.

18. The method of claim 1, further comprising:
maintaining a state indicator for the input box, and
determining whether to generate candidate messages based on a current state.

19. The method of claim 1, wherein stopping the generation of the at least one candidate message comprises:
evaluating a generation-completion state and an input-detection state, wherein the generation-completion state indicates whether candidate message generation has concluded, and the input-detection state indicates whether the user terminal has detected input in the input box.

20. The method of claim 19, wherein the input-detection state is updated based on a signal received from the user terminal indicating at least one of: (i) entry of a character into the input box, or (ii) dismissal of a keyboard object displayed for text input.

21. The method of claim 19, wherein the generation-completion state is determined based on a status of execution of the message generating model, the status indicating whether output representing the at least one candidate message has been fully generated.
